(19) United States
(12) Patent Application Publication
(10) Pub. No.: US 2025/0293399 A1
(43) Pub. Date: Sep. 18, 2025

(54) POWER STORAGE CELL AND METHOD FOR MANUFACTURING THE SAME

(71) Applicants: TOYOTA JIDOSHA KABUSHIKI KAISHA, Toyota-shi (JP); TOYOTA BATTERY CO., LTD., Kosai-shi (JP)

(72) Inventors: Masato ONO, Nagoya-shi (JP); Masahiro Ishizuka, Toyota-shi (JP); Atsushi Sugihara, Toyota-shi (JP); Yuka Yokoi, Nagoya-shi (JP); Tatsuya Yamamoto, Toyohashi-shi (JP); Keitaro Machida, Hamamatsu-shi (JP); Ryosuke Sato, Toyota-shi (JP)

(73) Assignees: TOYOTA JIDOSHA KABUSHIKI KAISHA, Toyota-shi (JP); TOYOTA BATTERY CO., LTD., Kosai-shi (JP)

(21) Appl. No.: 19/041,278

(22) Filed: Jan. 30, 2025

(30) Foreign Application Priority Data
Mar. 18, 2024 (JP) 2024-042039

(51) Int. Cl. H01M 50/474; H01M 10/0587; H01M 10/653; H01M 50/103; H01M 50/533

(52) U.S. Cl. CPC H01M 50/474; H01M 10/0587; H01M 10/653; H01M 50/103; H01M 50/533

(57) ABSTRACT

A power storage cell includes: a cell module including a plurality of cell units; a cell case that accommodates the cell module; and a bonding member provided within the cell case. The cell case is formed in a rectangular parallelepiped shape. The cell module has a facing corner that faces a three-dimensional corner of the cell case. The bonding member includes a corner bonding portion that bonds the three-dimensional corner of the cell case to the facing corner.

### CROSS REFERENCE TO RELATED APPLICATIONS

This nonprovisional application is based on Japanese Patent Application No. 2024-042039 filed on Mar. 18, 2024 with the Japan Patent Office, the entire contents of which are hereby incorporated by reference.

### BACKGROUND

### Field

The present disclosure relates to a power storage cell and a method for manufacturing the same.

### Description of the Background Art

For example, Japanese National Patent Publication No. 2023-509216 discloses a battery including a plurality of electrode body sets and a case that accommodates the plurality of electrode body sets. The plurality of electrode body sets are connected in series to each other by a first connecting member.

### SUMMARY

In the battery described in Japanese National Patent Publication No. 2023-509216, the electrode body sets may be relatively displaced with respect to the case due to vibration or the like.

An object of the present disclosure is to provide a power storage cell that can suppress relative displacement of a cell module with respect to a cell case, and a method for manufacturing the same.

A power storage cell according to one aspect of the present disclosure includes: a cell module including a plurality of cell units; a cell case that accommodates the cell module; and a bonding member provided within the cell case, wherein the cell case is formed in a rectangular parallelepiped shape, the cell module has a facing corner that faces a three-dimensional corner of the cell case, and the bonding member includes a corner bonding portion that bonds the three-dimensional corner of the cell case to the facing corner.

A method for manufacturing a power storage cell according to one aspect of the present disclosure is a method for manufacturing the power storage cell described above, the method including: an inserting step of inserting the cell module into the cell case; and a supplying step of supplying a bonding material for forming the bonding member into the cell case, wherein, in the supplying step, a supply tool is used, the supply tool having an accommodating portion that can accommodate the bonding material, and a discharging portion connected to the accommodating portion to discharge the bonding material, and the bonding material is supplied to the three-dimensional corner of the cell case by inserting the discharging portion between a corner of the cell case and the cell module.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a power storage cell according to one embodiment of the present disclosure.

FIG. 2 is an exploded perspective view of the power storage cell shown in FIG. 1.

FIG. 3 is a plan view of the power storage cell.

FIG. 4 is a cross sectional view taken along a line IV-IV in FIG. 3.

FIG. 5 is a cross sectional view taken along a line V-V in FIG. 3.

FIG. 6 is a cross sectional view schematically showing a step of supplying a bonding material into a cell case.

FIG. 7 is a cross sectional view schematically showing the step of supplying the bonding material into the cell case.

FIG. 8 is a cross sectional view schematically showing modifications of a corner bonding portion and an intermediate bonding portion.

FIG. 9 is a cross sectional view schematically showing modifications of an upper bonding portion and a lower bonding portion.

### DESCRIPTION OF THE PREFERRED EMBODIMENTS

An embodiment of the present disclosure will be described with reference to the drawings. It should be noted that, in the drawings referred to below, the same or corresponding members will be designated by the same reference numerals.

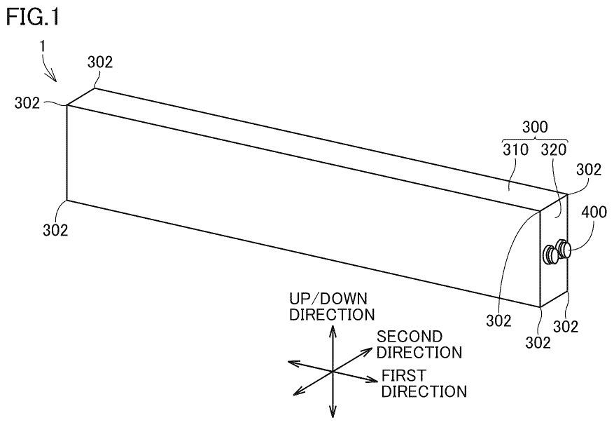

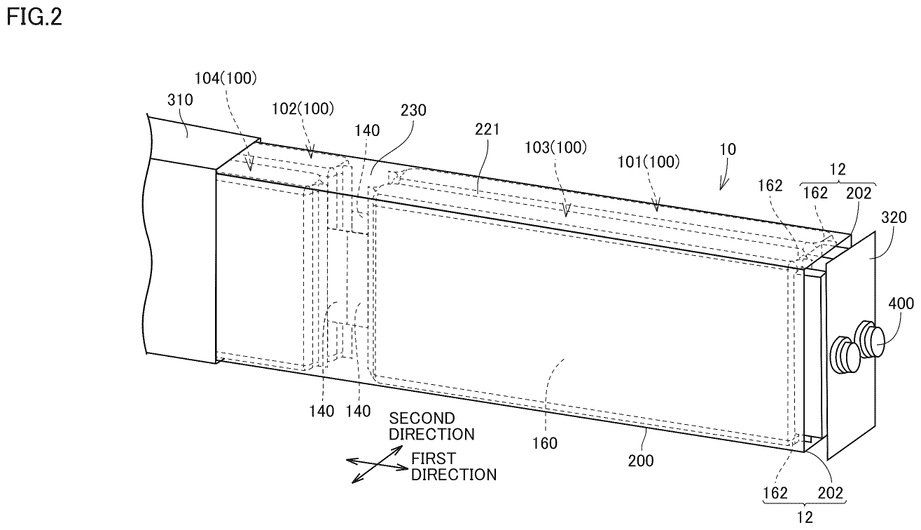

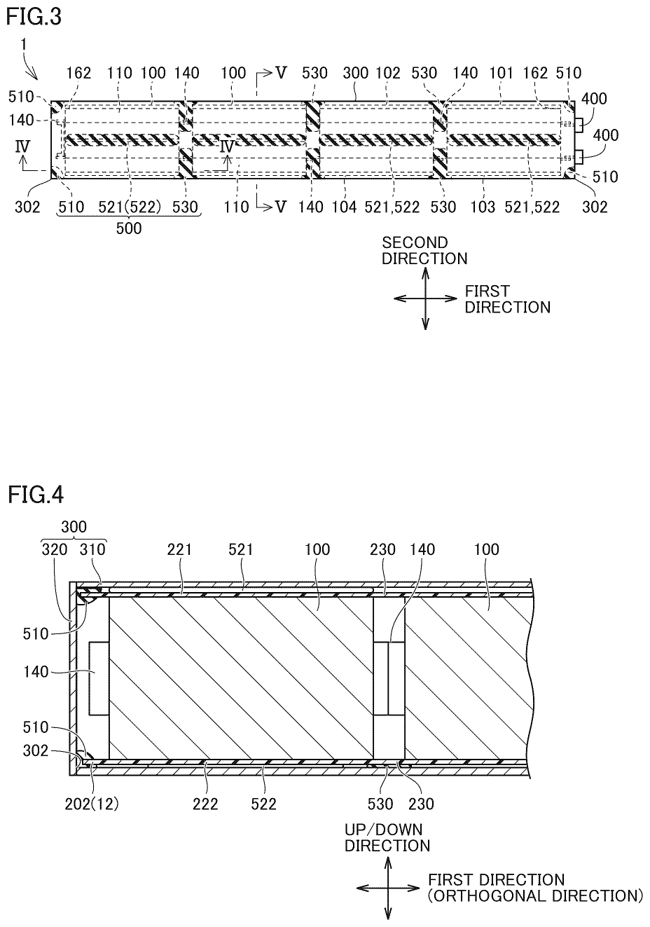

FIG. 1 is a perspective view schematically showing a power storage cell according to one embodiment of the present disclosure. FIG. 2 is an exploded perspective view of the power storage cell shown in FIG. 1. FIG. 3 is a plan view of the power storage cell. FIG. 4 is a cross sectional view taken along a line IV-IV in FIG. 3. FIG. 5 is a cross sectional view taken along a line V-V in FIG. 3. A power storage cell 1 is mounted on a bottom portion of a vehicle, for example.

As shown in FIGS. 1 to 5, power storage cell 1 includes a cell module 10 (see FIG. 2), a cell case 300, external terminals 400, and a bonding member 500. It should be noted that bonding member 500 is omitted in FIG. 2.

Cell module 10 includes a plurality of cell units 100. In the present embodiment, cell module 10 has the plurality of cell units 100 and a covering sheet 200. It should be noted that illustration of covering sheet 200 is omitted in FIG. 3.

As shown in FIG. 2, the plurality of cell units 100 include a first cell unit 101, a second cell unit 102, a third cell unit 103, and a fourth cell unit 104. In the present embodiment, the plurality of cell units 100 include eight cell units 100. However, the number of cell units 100 is not limited to eight. Each cell unit 100 may be a lithium-ion battery, for example. Each cell unit 100 may be constituted by a so-called all-solid-state battery containing a solid electrolyte.

First cell unit 101 is connected to second cell unit 102. Third cell unit 103 is connected to fourth cell unit 104. First cell unit 101 and second cell unit 102 are arranged in a first direction, and first cell unit 101 and third cell unit 103 are adjacent to each other in a second direction orthogonal to both the first direction and an up/down direction. Second cell unit 102 and fourth cell unit 104 are adjacent to each other in the second direction. Each cell unit 100 has a shape that extends longer in the first direction than in the second direction and extends longer in the first direction than in the up/down direction. Each cell unit 100 has a shape that extends longer in the up/down direction than in the second direction.

Each cell unit 100 has at least one electrode body 110 (see FIGS. 3 and 5), a current collector terminal 140, and a laminate exterior body 160.

The at least one electrode body 110 includes two electrode bodies 110. However, the number of electrode bodies 110 is not limited to two. Each electrode body 110 is constituted by a wound body in which a positive electrode sheet and a negative electrode sheet are wound with a separator being interposed therebetween. However, each electrode body 110 may be constituted by a stacked body in which a positive electrode sheet and a negative electrode sheet are stacked with a separator being interposed therebetween. The two electrode bodies 110 are adjacent to each other in a stacking direction (an up/down direction in FIG. 3) in which the positive electrode sheet and the negative electrode sheet are stacked on each other. Each electrode body 110 is formed in a shape elongated in an orthogonal direction orthogonal to both the stacking direction and the up/down direction. The stacking direction (a thickness direction) corresponds to the second direction, and the orthogonal direction corresponds to the first direction.

First cell unit 101 and third cell unit 103 are adjacent to each other in the stacking direction. That is, first cell unit 101 and third cell unit 103 are an example of “a pair of adjacent cell units” in the present disclosure. Similarly, second cell unit 102 and fourth cell unit 104 are an example of “a pair of adjacent cell units” in the present disclosure.

Further, first cell unit 101 and third cell unit 103 are disposed at an end portion in the orthogonal direction. That is, first cell unit 101 and third cell unit 103 are examples of “an endmost cell unit” in the present disclosure.

Current collector terminal 140 is connected to electrode body 110. Current collector terminal 140 protrudes from electrode body 110 in the orthogonal direction. Current collector terminal 140 electrically connected to the positive electrode sheet in electrode body 110 is made of aluminum, for example. Current collector terminal 140 electrically connected to the negative electrode sheet in electrode body 110 is made of copper, for example. Current collector terminal 140 is formed in a flat plate shape.

As shown in FIGS. 2 to 4, current collector terminal 140 in first cell unit 101 is connected to current collector terminal 140 in second cell unit 102. Similarly, current collector terminal 140 in third cell unit 103 is connected to current collector terminal 140 in fourth cell unit 104. That is, first cell unit 101 and second cell unit 102 are an example of “a pair of connected cell units” in the present disclosure. Similarly, third cell unit 103 and fourth cell unit 104 are an example of “a pair of connected cell units” in the present disclosure.

Laminate exterior body 160 accommodates each electrode body 110 and a portion of current collector terminal 140. Laminate exterior body 160 is made of a laminate film. Current collector terminal 140 protrudes outward in the orthogonal direction from an edge portion of laminate exterior body 160.

Covering sheet 200 covers the plurality of cell units 100. More specifically, covering sheet 200 covers the plurality of cell units 100 to surround these cell units 100 together. Covering sheet 200 is made of an insulating material (such as a synthetic resin). Since each electrode body 110 is constituted by a wound body, covering sheet 200 has curved corners as shown in FIG. 5.

Covering sheet 200 has an edge portion 202, an upper covering portion 221, a lower covering portion 222, and a surrounding portion 230.

Edge portion 202 is constituted by an end portion of covering sheet 200 in the orthogonal direction.

Upper covering portion 221 covers upper end portions 170 (see FIG. 5) of a pair of adjacent cell units adjacent to each other in the stacking direction. For example, upper covering portion 221 covers upper end portions 170 of first cell unit 101 and third cell unit 103. Upper covering portion 221 covers upper end portions 170 of second cell unit 102 and fourth cell unit 104.

Lower covering portion 222 covers lower end portions 180 (see FIG. 5) of the pair of adjacent cell units adjacent to each other in the stacking direction. For example, lower covering portion 222 covers lower end portions 180 of first cell unit 101 and third cell unit 103. Lower covering portion 222 covers lower end portions 180 of second cell unit 102 and fourth cell unit 104.

Surrounding portion 230 surrounds current collector terminals 140 in a pair of connected cell units. For example, surrounding portion 230 surrounds current collector terminal 140 in first cell unit 101 and current collector terminal 140 in second cell unit 102. Surrounding portion 230 surrounds current collector terminal 140 in third cell unit 103 and current collector terminal 140 in fourth cell unit 104.

Cell case 300 accommodates cell module 10. In the present embodiment, cell case 300 accommodates the plurality of cell units 100 and covering sheet 200. Cell case 300 is made of aluminum, for example. Cell case 300 is formed in a rectangular parallelepiped shape elongated in the first direction. Cell case 300 has eight three-dimensional corners 302. As shown in FIGS. 1 and 2, cell case 300 has a case main body 310 and a lid 320.

Case main body 310 is formed in a rectangular tube shape elongated in the first direction. Case main body 310 surrounds the plurality of cell units 100 and covering sheet 200.

Lid 320 is connected to case main body 310 by welding or the like, to close an opening in case main body 310.

In the present embodiment, each three-dimensional corner 302 is formed of three surfaces including two surfaces of case main body 310 adjacent to each other and lid 320. However, three-dimensional corner 302 may be constituted by a curved surface or the like, as long as it is in contact with three surfaces including two surfaces of case main body 310 adjacent to each other and lid 320. The “rectangular parallelepiped shape” indicating the outer shape of cell case 300 also includes a shape in which three-dimensional corner 302 is constituted by a curved surface or the like as described above.

External terminals 400 are provided on lid 320. External terminals 400 are connected to current collector terminals 140 in endmost cell units 101 and 103 disposed at positions closest to lid 320, of the plurality of cell units 100.

Cell module 10 has a facing corner 12 that faces three-dimensional corner 302 of cell case 300. Facing corner 12 includes edge portion 202 of covering sheet 200 in the orthogonal direction. Facing corner 12 may include a corner of an endmost cell unit. The corner of the endmost cell unit means a corner of the endmost cell unit that faces three-dimensional corner 302 of cell case 300. In the present embodiment, the corner of the endmost cell unit is constituted by a corner 162 of laminate exterior body 160.

Bonding member 500 is provided within cell case 300. Bonding member 500 is made of an insulating material. Bonding member 500 may be made of a thermally conductive adhesive. Bonding member 500 has a corner bonding portion 510, an upper bonding portion 521, a lower bonding portion 522, and an intermediate bonding portion 530.

Corner bonding portion 510 bonds three-dimensional corner 302 of cell case 300 to facing corner 12. In the present embodiment, corner bonding portion 510 bonds three-dimensional corner 302 of cell case 300 to edge portion 202 of covering sheet 200.

Upper bonding portion 521 bonds cell case 300 to upper covering portion 221. As shown in FIG. 5, upper bonding portion 521 is provided between an upper inner surface of case main body 310 and an upper surface of upper covering portion 221. Upper bonding portion 521 extends long in the orthogonal direction. The length of upper bonding portion 521 in the orthogonal direction may be equal to or shorter than the length of each cell unit 100 in the orthogonal direction. As shown in FIG. 3, upper bonding portion 521 is spaced apart from corner bonding portion 510.

As shown in FIGS. 3 and 5, upper bonding portion 521 straddles the upper end portions of the pair of adjacent cell units adjacent to each other in the stacking direction. As shown in FIG. 5, upper bonding portion 521 may have a shape that is convex toward a boundary portion between the pair of adjacent cell units adjacent to each other in the stacking direction (a shape that is convex downward). As shown in FIG. 5, upper bonding portion 521 is spaced apart from corners between an upper portion and side portions of case main body 310.

Lower bonding portion 522 bonds cell case 300 to lower covering portion 222. As shown in FIG. 5, lower bonding portion 522 is provided between a lower inner surface of case main body 310 and a lower surface of lower covering portion 222. Lower bonding portion 522 extends long in the orthogonal direction. The length of lower bonding portion 522 in the orthogonal direction may be equal to or shorter than the length of each cell unit 100 in the orthogonal direction. As shown in FIG. 3, lower bonding portion 522 is spaced apart from corner bonding portion 510.

As shown in FIGS. 3 and 5, lower bonding portion 522 straddles the lower end portions of the pair of adjacent cell units adjacent to each other in the stacking direction. As shown in FIG. 5, lower bonding portion 522 may have a shape that is convex toward the boundary portion between the pair of adjacent cell units adjacent to each other in the stacking direction (a shape that is convex upward). As shown in FIG. 5, lower bonding portion 522 is spaced apart from corners between a lower portion and the side portions of case main body 310.

Intermediate bonding portion 530 bonds cell case 300 to surrounding portion 230. As shown in FIGS. 3 and 4, intermediate bonding portion 530 is provided between an inner surface of case main body 310 and an outer surface of surrounding portion 230. As shown in FIGS. 3 and 4, intermediate bonding portion 530 is spaced apart from upper bonding portion 521. Intermediate bonding portion 530 may be spaced apart from lower bonding portion 522.

In the present embodiment, bonding member 500 has only corner bonding portion 510, upper bonding portion 521, lower bonding portion 522, and intermediate bonding portion 530. In other words, the bonding member is not provided at a portion of an inner surface of cell case 300 other than portions in contact with corner bonding portion 510, upper bonding portion 521, lower bonding portion 522, and intermediate bonding portion 530.

Next, a method for manufacturing power storage cell 1 will be described. The manufacturing method includes a covering step, an inserting step, and a supplying step.

In the covering step, the plurality of cell units 100 are covered with covering sheet 200.

In the inserting step, cell module 10 is inserted into case main body 310 along the first direction.

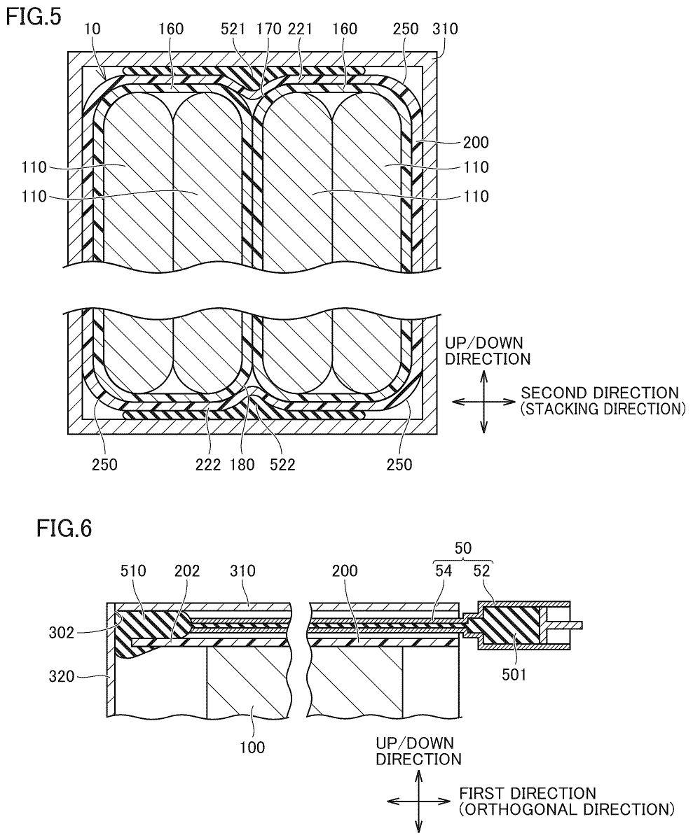

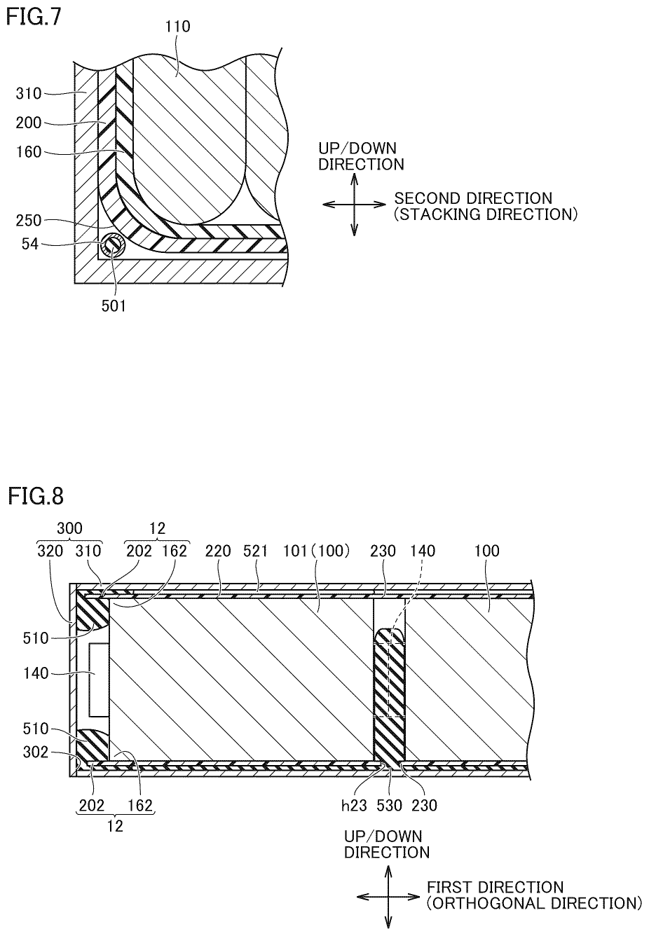

Subsequently, the supplying step will be described with reference to FIGS. 6 and 7. In the supplying step, a bonding material 501 for forming bonding member 500 is supplied into cell case 300. In the supplying step, a supply tool 50 that can supply bonding material 501 is used. Supply tool 50 has an accommodating portion 52 that can accommodate bonding material 501, and a discharging portion 54 that discharges bonding material 501. Accommodating portion 52 may be a syringe, for example. Discharging portion 54 is formed in a cylindrical shape. A base end portion of discharging portion 54 is connected to accommodating portion 52. The length of discharging portion 54 in the first direction is substantially equal to the length of case main body 310 in the first direction.

In the supplying step, discharging portion 54 is inserted into a gap between case main body 310 and cell module 10 disposed within case main body 310. On this occasion, as shown in FIG. 7, discharging portion 54 may be inserted between a corner of case main body 310 and corner 250 of covering sheet 200. Then, bonding material 501 accommodated in accommodating portion 52 is discharged from discharging portion 54 to, for example, three-dimensional corner 302 of cell case 300, and the like. Thereby, corner bonding portion 510 is formed. Upper bonding portion 521, lower bonding portion 522, and intermediate bonding portion 530 are also formed by the same operation as described above.

Then, lid 320 is welded to case main body 310, and thereby power storage cell 1 is formed.

As described above, in power storage cell 1 according to the present embodiment, since three-dimensional corner 302 of cell case 300 and facing corner 12 of cell module 10 are bonded by corner bonding portion 510, relative displacement of cell module 10 with respect to cell case 300 is effectively suppressed.

Further, since upper covering portion 221 is bonded to cell case 300 by upper bonding portion 521 and lower covering portion 222 is bonded to cell case 300 by lower bonding portion 522, the relative displacement of cell module 10 with respect to cell case 300 is more suppressed.

In addition, since surrounding portion 230 is bonded to cell case 300 by intermediate bonding portion 530, the relative displacement of cell module 10 with respect to cell case 300 is further suppressed.

Hereinafter, modifications of the embodiment described above will be described.

### <First Modification>

As shown in FIG. 8, corner bonding portion 510 may bond three-dimensional corner 302 of cell case 300 to edge portion 202 of covering sheet 200 and corner 162 of the endmost cell unit.

In this aspect, since both covering sheet 200 and the endmost cell unit are bonded to cell case 300 by corner bonding portion 510, the relative displacement of cell module 10 with respect to cell case 300 is more reliably suppressed.

### <Second Modification>

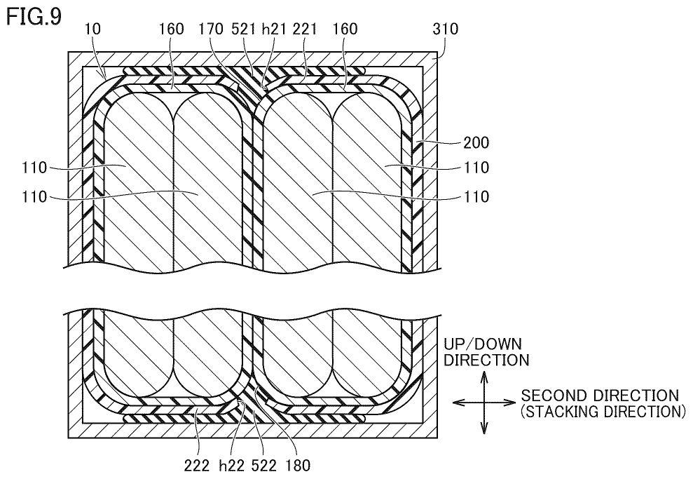

As shown in FIG. 9, upper bonding portion 521 may bond cell case 300 to upper covering portion 221 and upper end portions 170 of the pair of adjacent cell units. In this example, upper covering portion 221 is provided with a through hole h21. Accordingly, the bonding material supplied between cell case 300 and upper covering portion 221 in the supplying step comes into contact with upper end portions 170 of the pair of adjacent cell units, via through hole h21.

In this aspect, since both covering sheet 200 and the pair of adjacent cell units are bonded to cell case 300 by upper bonding portion 521, the relative displacement of cell module 10 with respect to cell case 300 is more reliably suppressed.

### <Third Modification>

As in the second modification, lower bonding portion 522 may bond cell case 300 to lower covering portion 222 and lower end portions 180 of the pair of adjacent cell units. In this example, lower covering portion 222 is provided with a through hole h22. Accordingly, the bonding material supplied between cell case 300 and lower covering portion 222 in the supplying step comes into contact with lower end portions 180 of the pair of adjacent cell units, via through hole h22.

### <Fourth Modification>

As shown in FIG. 8, intermediate bonding portion 530 may bond cell case 300 to surrounding portion 230 and current collector terminals 140 in the pair of connected cell units. In this example, surrounding portion 230 is provided with a through hole h23. Accordingly, the bonding material supplied between cell case 300 and surrounding portion 230 in the supplying step covers current collector terminals 140, via through hole h23.

In this aspect, detachment between current collector terminals 140 due to vibration or the like is suppressed. Further, since bonding member 500 is made of an insulating material, occurrence of a short circuit due to the contact of a connection portion between current collector terminal 140 in first cell unit 101 and current collector terminal 140 in second cell unit 102 with a connection portion between current collector terminal 140 in third cell unit 103 and current collector terminal 140 in fourth cell unit 104 is suppressed.

It will be understood by those skilled in the art that the exemplary embodiment described above is a specific example of the following aspects.

### [Aspect 1]

A power storage cell including:
a cell module including a plurality of cell units;
a cell case that accommodates the cell module; and
a bonding member provided within the cell case, wherein
the cell case is formed in a rectangular parallelepiped shape,
the cell module has a facing corner that faces a three-dimensional corner of the cell case, and
the bonding member includes a corner bonding portion that bonds the three-dimensional corner of the cell case to the facing corner.

In the power storage cell, since the three-dimensional corner of the cell case and the facing corner of the cell module are bonded by the corner bonding portion, relative displacement of the cell module with respect to the cell case is effectively suppressed.

### [Aspect 2]

The power storage cell according to aspect 1, wherein
the cell module further includes a covering sheet that covers the plurality of cell units together,
each of the plurality of cell units includes
   an electrode body, and
   a current collector terminal that protrudes from the electrode body in an orthogonal direction orthogonal to both a stacking direction of the electrode body and an up/down direction, and
the facing corner includes an edge portion of the covering sheet in the orthogonal direction.

### [Aspect 3]

The power storage cell according to aspect 2, wherein
the plurality of cell units include an endmost cell unit disposed at an end portion in the orthogonal direction,
the endmost cell unit has a corner that faces the three-dimensional corner of the cell case,
the facing corner further includes the corner of the endmost cell unit, and
the corner bonding portion bonds the three-dimensional corner of the cell case to the edge portion of the covering sheet and the corner of the endmost cell unit.

In this aspect, since both the covering sheet and the endmost cell unit are bonded to the cell case by the corner bonding portion, the relative displacement of the cell module with respect to the cell case is more reliably suppressed.

### [Aspect 4]

The power storage cell according to aspect 2 or 3, wherein
the plurality of cell units include a pair of adjacent cell units adjacent to each other in the stacking direction,
the covering sheet includes an upper covering portion that covers upper end portions of the pair of adjacent cell units, and
the bonding member includes an upper bonding portion that bonds the cell case to the upper covering portion.

In this aspect, since the upper covering portion is bonded to the cell case by the upper bonding portion, the relative displacement of the cell module with respect to the cell case is suppressed.

### [Aspect 5]

The power storage cell according to aspect 4, wherein
the upper covering portion is provided with a through hole, and
the upper bonding portion bonds the cell case to the upper covering portion and the upper end portions of the pair of adjacent cell units.

In this aspect, since both the upper covering portion and the pair of adjacent cell units are bonded to the cell case by the upper bonding portion, the relative displacement of the cell module with respect to the cell case is more reliably suppressed.

### [Aspect 6]

The power storage cell according to any one of aspects 2 to 5, wherein
the plurality of cell units include a pair of adjacent cell units adjacent to each other in the stacking direction,
the covering sheet includes a lower covering portion that covers lower end portions of the pair of adjacent cell units, and
the bonding member includes a lower bonding portion that bonds the cell case to the lower covering portion.

In this aspect, since the lower covering portion is bonded to the cell case by the lower bonding portion, the relative displacement of the cell module with respect to the cell case is suppressed.

### [Aspect 7]

The power storage cell according to aspect 6, wherein
the lower covering portion is provided with a through hole, and
the lower bonding portion bonds the cell case to the lower covering portion and the lower end portions of the pair of adjacent cell units.

In this aspect, since both the lower covering portion and the pair of adjacent cell units are bonded to the cell case by the lower bonding portion, the relative displacement of the cell module with respect to the cell case is more reliably suppressed.

### [Aspect 8]

The power storage cell according to any one of aspects 2 to 7, wherein
the plurality of cell units include a pair of connected cell units connected to each other in the orthogonal direction,
the current collector terminal in one connected cell unit of the pair of connected cell units is connected to the current collector terminal in another connected cell unit of the pair of connected cell units,
the covering sheet includes a surrounding portion that surrounds the current collector terminals in the pair of connected cell units, and
the bonding member includes an intermediate bonding portion that bonds the cell case to the surrounding portion.

In this aspect, since the surrounding portion is bonded to the cell case by the intermediate bonding portion, the relative displacement of the cell module with respect to the cell case is suppressed.

### [Aspect 9]

The power storage cell according to aspect 8, wherein
the surrounding portion is provided with a through hole, and
the intermediate bonding portion bonds the cell case to the surrounding portion and the current collector terminals in the pair of connected cell units.

In this aspect, detachment between the current collector terminals due to vibration or the like is suppressed.

### [Aspect 10]

The power storage cell according to any one of aspects 1 to 9, wherein the bonding member is made of a thermally conductive adhesive.

In this aspect, the cell units are effectively cooled by cooling the cell case.

### [Aspect 11]

A method for manufacturing the power storage cell according to any one of aspects 1 to 10, the method including:
an inserting step of inserting the cell module into the cell case; and
a supplying step of supplying a bonding material for forming the bonding member into the cell case, wherein
in the supplying step, a supply tool is used, the supply tool having an accommodating portion that can accommodate the bonding material, and a discharging portion connected to the accommodating portion to discharge the bonding material, and
the bonding material is supplied to the three-dimensional corner of the cell case by inserting the discharging portion between a corner of the cell case and the cell module.

Although the embodiment of the present disclosure has been described, it should be understood that the embodiment disclosed herein is illustrative and non-restrictive in every respect. The scope of the present disclosure is defined by the scope of the claims, and is intended to include any modifications within the scope and meaning equivalent to the scope of the claims.

What is claimed is:

1. A power storage cell comprising:
a cell module including a plurality of cell units;
a cell case that accommodates the cell module; and
a bonding member provided within the cell case, wherein
the cell case is formed in a rectangular parallelepiped shape,
the cell module has a facing corner that faces a three-dimensional corner of the cell case, and
the bonding member includes a corner bonding portion that bonds the three-dimensional corner of the cell case to the facing corner.

2. The power storage cell according to claim 1, wherein
the cell module further includes a covering sheet that covers the plurality of cell units together,
each of the plurality of cell units includes
an electrode body, and
a current collector terminal that protrudes from the electrode body in an orthogonal direction orthogonal to both a stacking direction of the electrode body and an up/down direction, and
the facing corner includes an edge portion of the covering sheet in the orthogonal direction.

3. The power storage cell according to claim 2, wherein
the plurality of cell units include an endmost cell unit disposed at an end portion in the orthogonal direction,
the endmost cell unit has a corner that faces the three-dimensional corner of the cell case,
the facing corner further includes the corner of the endmost cell unit, and
the corner bonding portion bonds the three-dimensional corner of the cell case to the edge portion of the covering sheet and the corner of the endmost cell unit.

4. The power storage cell according to claim 2, wherein
the plurality of cell units include a pair of adjacent cell units adjacent to each other in the stacking direction,
the covering sheet includes an upper covering portion that covers upper end portions of the pair of adjacent cell units, and
the bonding member includes an upper bonding portion that bonds the cell case to the upper covering portion.

5. The power storage cell according to claim 4, wherein
the upper covering portion is provided with a through hole, and
the upper bonding portion bonds the cell case to the upper covering portion and the upper end portions of the pair of adjacent cell units.

6. The power storage cell according to claim 2, wherein
the plurality of cell units include a pair of adjacent cell units adjacent to each other in the stacking direction,
the covering sheet includes a lower covering portion that covers lower end portions of the pair of adjacent cell units, and
the bonding member includes a lower bonding portion that bonds the cell case to the lower covering portion.

7. The power storage cell according to claim 6, wherein
the lower covering portion is provided with a through hole, and
the lower bonding portion bonds the cell case to the lower covering portion and the lower end portions of the pair of adjacent cell units.

8. The power storage cell according to claim 2, wherein
the plurality of cell units include a pair of connected cell units connected to each other in the orthogonal direction,
the current collector terminal in one connected cell unit of the pair of connected cell units is connected to the current collector terminal in another connected cell unit of the pair of connected cell units,
the covering sheet includes a surrounding portion that surrounds the current collector terminals in the pair of connected cell units, and
the bonding member includes an intermediate bonding portion that bonds the cell case to the surrounding portion.

9. The power storage cell according to claim 8, wherein
the surrounding portion is provided with a through hole, and
the intermediate bonding portion bonds the cell case to the surrounding portion and the current collector terminals in the pair of connected cell units.

10. The power storage cell according to claim 1, wherein the bonding member is made of a thermally conductive adhesive.

11. A method for manufacturing the power storage cell according to claim 1, the method comprising:
an inserting step of inserting the cell module into the cell case; and
a supplying step of supplying a bonding material for forming the bonding member into the cell case, wherein
in the supplying step, a supply tool is used, the supply tool having an accommodating portion that can accommodate the bonding material, and a discharging portion connected to the accommodating portion to discharge the bonding material, and the bonding material is supplied to the three-dimensional corner of the cell case by inserting the discharging portion between a corner of the cell case and the cell module.
